(19) United States
(12) Patent Application Publication
(10) Pub. No.: US 2008/0210646 A1
(43) Pub. Date: Sep. 4, 2008

(54) Centrifuge Rotor and Method of Use

(76) Inventor: Marcus J. Horn, Parsippany, NJ (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/916,360

(22) PCT Filed: Jun. 3, 2005
(86) PCT No.: PCT/US05/19587

§ 371 Date: Dec. 3, 2007

(51) Int. Cl. B04B 7/12; B01D 21/26

(52) U.S. Cl. 210/788; 494/45

(57) ABSTRACT

The present invention is directed to a centrifuge rotor (10) having a rotor housing (14) with a substantially cylindrical in shape and having a substantially uniform opening extending through the center of the housing and along a length thereof, a rotor core (16) having a substantially cylindrical shape and sized and shaped to fit within the opening of the rotor housing. The rotor core further has at least two channels (30) in an outer surface thereof such that the channels, along with an interior wall of the rotor housing, define two sample spaces into which sample is delivered while the rotor is in operation.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### BACKGROUND OF THE INVENTION

The present invention is directed generally to an ultracentrifuge rotor, and more specifically to an ultracentrifuge rotor capable of separating or concentrating a continuous flow sample into a small volume, and a method of using the same.

The use of centrifuges to separate the components of a sample is well-known. Various types and styles of centrifuge currently exist for various applications in chemistry, biology, and other arts. Each centrifuge device contains a sample, usually in the form of a liquid contained in a test tube or other receptacle, and which rotates at high speed to induce separation of individual components of the sample.

Angle-head rotors are among the most common centrifuge rotors and generally include a rotor body, a lid with a handle for opening and closing thereof, and a plurality of spaces sized and shaped to receive capped test tubes or other sample-containing receptacles. The spaces are generally disposed at an angle for high-efficiency of centrifugation, among other reasons.

Analytical rotors are commonly used to study optically samples being sedimented during centrifugation. These rotors generally include a rotor body, cell holders into which samples are placed, and quartz or sapphire windows through which the sample in the centrifuge can be monitored.

Swinging rotors are typically used with glass test tubes that may be capped or uncapped, and are often used for centrifugation of samples in clinical laboratories. When the tubes are loaded into a swinging rotor, their long axes are vertical. During centrifugation, the long axes of the test tubes become nearly horizontal due to centrifugal force, achieving a good degree of separation of the sample.

In addition to the rotors described above, which are used to centrifuge discreet samples, centrifuge rotors for use with continuous-flow samples are also known. Disk-type centrifuge rotors are one example of centrifuge rotors used with continuous flow samples. These rotors typically include conical disks inside a hollow frustum of a cone. As a fluid sample passes through the center of the cone, solid particles sediment against the disk and move to the periphery of the rotor.

Tubular clarifier rotors have internal dams that provide a means for separating particles or components of a continuous-flow sample stream. Due to the long rotor length, the sample is within the rotor for a sufficient time to allow radial separation of different materials.

Finally, zonal rotors provide the flexibility of using either long tubular rotors having large length to diameter (L/D) ratios, or very short, disk-like rotors having small L/D ratio to perform the same task. Large L/D ratio rotors produce high centrifugal fields but sacrifice radial sedimentation path. Small L/D ratio rotors produce a larger radial sedimentation path while producing smaller centrifugal fields. These rotors have certain moments of inertia, I(spin) and I(transverse), with certain ratios of moments of inertia [I(spin)/I(transverse)]. Long tubular rotors have moment of inertia ratios which approach zero, while very short disk-like rotors have moment of inertia ratios which approach two. Centrifuge rotors having moment of inertia ratios approaching zero or two are generally considered in the art to be stable. Centrifuge rotors having moment of inertia ratios in the midrange, where the ratios are one, and where the L/D ratios approach one are considered unstable.

In each of the above known rotors, large sample volumes are typically used. This is especially true in the continuous-flow rotors, where sample volumes of over one liter are needed for separation applications. There exists a need for a centrifuge rotor capable of separating a continuous-flow sample, yet having a small enough volume contained within the rotor that the sample can be removed or drained into receptacles common to microbiology, such as microtubes or microtitre plates. There also exists a need for a continuous-flow centrifuge rotor having a small enough volume to effectively concentrate trace components of a sample in a small volume of fluid.

### BRIEF SUMMARY OF THE INVENTION

The present invention is directed to a centrifuge rotor having a rotor housing with a substantially cylindrical in shape and having a substantially uniform opening extending through the center of the housing and along a length thereof, a rotor core having a substantially cylindrical shape and sized and shaped to fit within said the opening of the rotor housing. The rotor core further has at least two channels in an outer surface thereof such that the channels, along with an interior wall of the rotor housing, define two sample spaces into which sample is delivered while the rotor is in operation. The sample spaces in the present rotor are preferably sized such that the rotor, as a whole, contains 100 ml of sample, or less. Further, the rotor of the present invention has an L/D ratio in the range of from about 0.9 to about 1.3.

In preferred embodiments of the present invention, the rotor of the present invention preferably has an L/D ratio in the range of from about 1.03 to about 1.30, and more preferably in the range of from about 1.03 to about 1.25, and even more preferably in the range of from about 1.03 to about 1.20. More preferable still is a rotor with an L/D ratio in the range of from about 1.03 to about 1.15, and more preferable are L/D ratios in the ranges of from about 1.03 to about 1.10, and from about 1.03 to about 1.05, respectively. Most preferred is an L/D ratio of about 1.03.

In another aspect of the present invention, for each of the L/D ratios given above with respect to the centrifuge rotor as a whole, it is preferred that the rotor core, taken separately from the centrifuge rotor as a whole and independent of any L/D ratio of the rotor as a whole, has the same preferred ranges of L/D ratio as described above. In a most preferred embodiment, the rotor core has an L/D ratio of about 1.03, irrespective of any L/D ratio that the rotor as a whole might have.

The present device also preferably includes a first end cap removably attached to one end of the rotor housing, the first end cap also having a fluid inlet associated therewith.

Further, the present device preferably includes a second end cap removably attached to the other end of the rotor housing, the second end cap also having a fluid outlet associated therewith.

Preferably, the present device includes a seal ring positioned between the first end cap and the rotor housing for creating a seal between the first end cap and the rotor housing, as well as a second seal ring positioned between the second end cap and the rotor housing for creating a seal between the second end cap and the rotor housing.

In a preferred embodiment, four sample spaces are utilized, each sized and shaped to contain about 25 ml of sample fluid, providing a centrifuge rotor having a total capacity of about 100 ml. In a more preferred embodiment, four sample spaces are utilized, each sized and shaped to provide a rotor with a total capacity of from about 25 ml to about 300 ml, or other ranges therebetween. Most preferred is a centrifuge rotor having four sample chambers sized and shaped to provide a rotor with a total capacity of about 25 ml.

The present invention is also directed to a method of using the rotor described above. The method includes introducing a gradient-forming solution into the centrifuge rotor and spinning the rotor so that the gradient-forming solution forms a vertical gradient inside the rotor. Next, a continuous-flow fluid sample is allowed to flow into the rotor through the fluid inlet such that components of the sample are separated by the gradient within the rotor. The sample is allowed to flow through the rotor for a predetermined length of time in order to fully separate or concentrate the desired components. Then, the centrifuge is stopped such that the vertical gradient within the centrifuge shifts to form a horizontal gradient, also shifting the separated sample in the process. Finally, the sample is removed from the centrifuge rotor and collected in fractions according to the gradient containing the separated sample.

### BRIEF DESCRIPTION OF THE DRAWINGS

FIG. 1 is an exploded view of a centrifuge rotor in accordance with the teachings of the present invention.

FIG. 2 is a cross-sectional view of a centrifuge rotor core and housing constructed in accordance with the teachings of the present invention.

FIG. 3A is a longitudinal cross-sectional view of a centrifuge rotor core and housing constructed in accordance with the teachings of the present invention.

FIG. 3B is a longitudinal cross-sectional view of a centrifuge rotor core and housing constructed in accordance with the teachings of the present invention and showing the sample chambers therein.

FIG. 4 is a schematic view of various steps involved in the use of the present rotor.

### DETAILED DESCRIPTION OF THE INVENTION

Using the teachings of the present invention, it has been unexpectedly found that a centrifuge rotor with an L/D ratio approaching one is made stable. Such rotors are considered in the art to be unstable and therefore unsuitable for use. In the case of the present rotor, however, an L/D ratio approaching one is preferred.

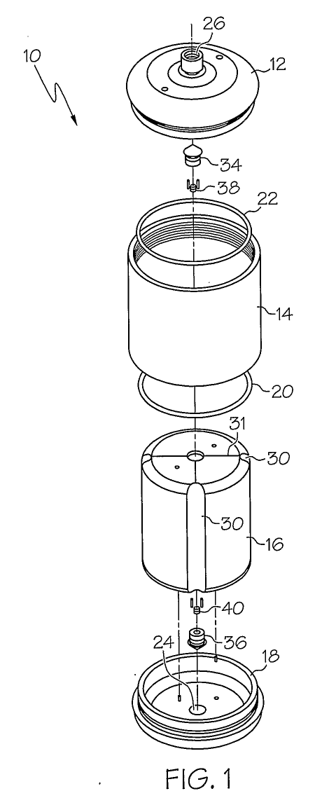

Referring now to the drawings, wherein like numerals represent like parts, FIG. 1 is an exploded view of a centrifuge rotor 10 constructed in accordance with the teachings of the present invention. Centrifuge rotor 10 includes generally a top end cap 12, a rotor housing 14, a rotor core 16, a bottom end cap 18, and first and second sealing O-rings 20 and 22. Centrifuge rotor 10 further includes fluid inlet 24 and fluid outlet 26.

Top end cap 12 serves to close the upper end of centrifuge rotor 10 in order to maintain the integrity thereof such that fluid may be retained within the rotor. Top end cap 12 preferably screws tightly into place, though any other suitable method of attaching the end cap may also be used, including snapping the cap into place. The method of removably attaching top end cap 12 to centrifuge rotor 10 should be such that top end cap 12 is attached securely to rotor housing 14 and does not allow leakage of fluid therefrom. Further to this end, an o-ring 22 is provided with top end cap 12 in order to ensure that a tight seal is formed between top end cap 12 and rotor housing 14. Top end cap 12 is preferably constructed from titanium, stainless steel or aluminum, though any suitable material may be used. O-ring 22 may be constructed from traditional sealing ring materials, such as rubber or synthetic polymers, although any suitable material may be used. In the case of both top end cap 12 and o-ring 22, the materials used in the construction of these components may vary depending on the chemicals likely to contact these components during a particular use of centrifuge rotor 10.

Rotor housing 14 is a cylindrical structure open on both ends and with a hollow interior for inclusion of a rotor core 16 therein. The width of the wall of rotor housing 14 is preferably substantially uniform across the entire length of rotor housing 14, as is the interior diameter thereof. The length of rotor housing 14 is dependent upon the length of the rotor core 16 used therein, and is substantially the same as the length of rotor core 16. Factors taken into consideration with respect to determining the length of rotor core 16 are described more fully below. Rotor housing 14 is preferably constructed from the same material as top end cap 12, and the considerations cited with respect to top end cap 12 in terms of chemicals contacting the component during use of centrifuge rotor 10 also apply to rotor housing 14. It is contemplated that any suitable construction materials are included within the scope of the present invention, and that the recitation of specific materials herein is exemplary and not limiting.

Contained within rotor housing 14 are distributors 34 and 36. These distributors are conical in shape and adapted to mate with corresponding conical indentations in the undersurfaces of top end cap 12 and bottom end cap 18, respectively. The action of spring 38 against distributor 34 causes distributor 34 to firmly contact an undersurface of top end cap 12. Likewise, the action of spring 40 against distributor 36 causes distributor 36 to firmly contact an undersurface of bottom end cap 18. When a fluid sample is introduced through either of fluid inlet 24 or fluid outlet 26, the corresponding distributor ensures that the fluid sample is distributed evenly to rotor core 16. The use of such distributors in centrifuge rotors is known in the art.

In preferred embodiments of the present invention, the rotor of the present invention preferably has an L/D ratio in the range of from about 1.03 to about 1.30, and more preferably in the range of from about 1.03 to about 1.25, and even more preferably in the range of from about 1.03 to about 1.20. More preferable still is a rotor with an L/D ratio in the range of from about 1.03 to about 1.15, and more preferable are L/D ratios in the ranges of from about 1.03 to about 1.10, and from about 1.03 to about 1.05, respectively. Most preferred is an L/D ratio of about 1.03.

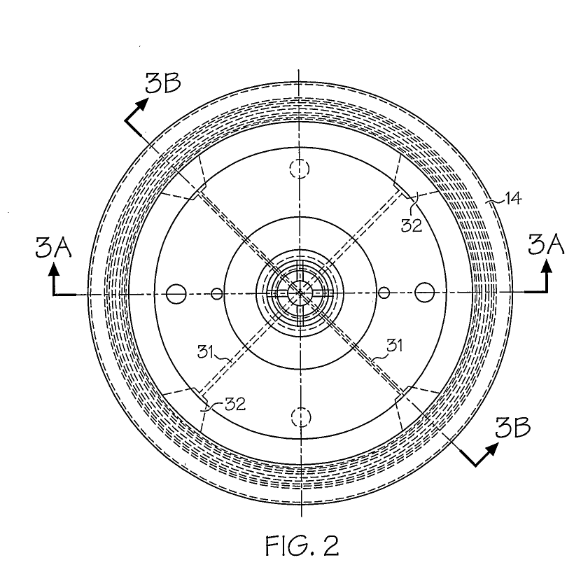

As best seen in FIG. 2, rotor core 16 has four cross-channels 31 on an upper surface thereof. These cross-channels serve to move fluid entering through fluid inlet 24 into longitudinal channels 30 (referred to hereinafter alternatively as “channels” or “longitudinal channels”). The lower surface of rotor core 16 (not shown) includes similar channels. It is preferred that the number of cross-channels 31 is equal to the number of longitudinal channels 30, such that a cross-channel 31 runs from the center of rotor core 16 to each of longitudinal channels 30.

In preferred embodiments of the present invention, the rotor core of the present invention preferably has an L/D ratio in the range of from about 1.03 to about 1.30, and more preferably in the range of from about 1.03 to about 1.25, and even more preferably in the range of from about 1.03 to about 1.20. More preferable still is a rotor with an L/D ratio in the range of from about 1.03 to about 1.15, and more preferable are L/D ratios in the ranges of from about 1.03 to about 1.10, and from about 1.03 to about 1.05, respectively. Most preferred is an L/D ratio of about 1.03.

Rotor core 16 is generally cylindrical in shape and is of substantially the same length as rotor housing 14. A cross-sectional view of rotor core 16 inside rotor housing 14 is provided in FIG. 2. The diameter of rotor core 16 is preferably slightly less than the internal diameter of rotor housing 14, such that rotor core 16 fits snugly within rotor housing 14. Rotor core 16 further includes four channels 30 extending lengthwise along an edge thereof. When centrifuge rotor 16 is in place inside rotor housing 14, as shown in FIG. 2, sample chambers 32 are formed, said sample chambers being defined on three sides by the walls of channels 30, and on one side by an interior wall of rotor housing 14. As shown in the Figures, in a preferred embodiment of the present invention, four channels 30 are included in rotor core 16, each equally spaced around a circumference of rotor core 16 such that the balance of rotor core 16, and therefore of centrifuge rotor 10, is maintained when centrifuge rotor 10 is in use. It is contemplated, however, that any number of channels 30 may be included in rotor core 16 so long as channels 30 are spaced along the circumference of rotor core 16 in such a manner to preserve the balance of rotor core 16 and centrifuge rotor 10. Rotor core 16 is preferably constructed from titanium, although other materials such as polyetheretherketone (PEEK) and polyphenilen oxide (NORYL) may also be used in construction of rotor core 16, although materials should be chosen for chemical compatibility with chemicals to be used in centrifuge rotor 10. That is, the materials used in the construction of rotor core 16 should be resistant to degradation and the like due to chemicals contacting rotor core 16 during use of centrifuge rotor 10. Table 1, below, provides a non-exhaustive list of chemical compatibilities for titanium, PEEK, and NORYL.

TABLE 1
Chemical compatibilities.

| | Titanium | PEEK | NORYL |
|---|---|---|---|
| Ammonium Nitrate | Compatible | Compatible | Compatible |
| Ammonium Phosphate | Compatible | Compatible | Compatible |
| Benzethonium Chloride | Compatible | Compatible | Compatible |
| Caesium Chloride | Compatible | Compatible | Compatible |
| Lithium Bromide | Compatible | Compatible | Compatible |
| Magnesium Chloride | Compatible | Compatible | Compatible |
| Potassium Acetate | Compatible | Compatible | Compatible |
| Potassium Bicarbonate | Compatible | Compatible | Compatible |
| Potassium Chloride | Compatible | Compatible | Compatible |
| Potassium Nitrate | Compatible | Compatible | Compatible |
| Sodium Bicarbonate | Compatible | Compatible | Compatible |
| Sodium Borate | Compatible | Compatible | Compatible |
| Sodium Chloride | Compatible | Compatible | Compatible |
| Trisodium Phosphate | Compatible | Compatible | Compatible |
| Hydrocarbon Solvents | Compatible | Incompatible | Incompatible |
| Acetic Acid | Compatible | Compatible | Compatible |
| Hydrochloric Acid | Incompatible | Compatible | Compatible |
| Hydrobromic Acid | Incompatible | Incompatible | Compatible |
| Hydrofluoric Acid | Incompatible | Incompatible | Compatible |
| Nitric Acid | Compatible | Incompatible | Compatible |
| Phosphoric Acid | Incompatible | Compatible | Compatible |
| Sulfuric Acid | Incompatible | Incompatible | Compatible |
| Bleach | Incompatible | Compatible | Compatible |
| Liquid Detergent Soap | Incompatible | Compatible | Compatible |
| (10% or 100% | | | |
| concentration) | | | |
| Mild, non-Alkaline | Incompatible | Compatible | Compatible |
| Detergent | | | |
| Ethylene Oxide | Incompatible | Compatible | Compatible |
| Ethylene Oxide and | Incompatible | Compatible | Compatible |
| Freons | | | |
| Freon 22 | Incompatible | Compatible | Compatible |
| Oxygen | Incompatible | Compatible | Compatible |
| Propane | Incompatible | Compatible | Compatible |
| Sulfur Dioxide | Incompatible | Compatible | Compatible |

The diameter of each of channels 30 is preferably such that each sample chamber 32 formed between said channels 30 and rotor housing 14 holds a volume of 25 ml. As the length of rotor core 16 (and thus, rotor housing 14) varies with different embodiments of the present invention, it is preferred that the cross-sectional diameter of each sample chamber 32 is increased (in the case of a smaller length of rotor core 16), or decreased (in the case of a greater length of rotor core 16), in order to maintain a volume of 25 ml within each of sample chambers 32. As the length of rotor core 16 is increased or decreased, and the cross-sectional area of sample chambers 32 is correspondingly increased or decreased (thereby altering the length/diameter ratios of sample chambers 32), the pressure of a sample fluid flowing into centrifuge rotor 10 through fluid inlet 24 (described below) must be increased or decreased in order to maintain a constant flow rate through centrifuge rotor 10. Determining the pressure necessary to achieve a certain flow rate for a given internal diameter of sample chambers 32 is a matter of fluid dynamics and mathematics known to those of skill in the art.

Bottom end cap 18 serves to close the lower end of centrifuge rotor 10 in order to maintain the integrity thereof such that fluid may be retained within the centrifuge rotor 10. Bottom end cap 18 preferably screws tightly into place, though any other suitable method of attaching the end cap may also be used, including snapping the cap into place. The method of removably attaching bottom end cap 18 to centrifuge rotor 10 should be such that bottom end cap 18 is attached securely to rotor housing 14 and does not allow leakage of fluid therefrom. Further to this end, an o-ring 20 is provided with bottom end cap 18 in order to ensure that a tight seal is formed between bottom end cap 18 and rotor housing 14. Bottom end cap 18 is preferably constructed from titanium, stainless steel or aluminum, though any suitable material may be sued. O-ring 20 may be constructed from traditional sealing ring materials, such as rubber or synthetic polymers, although any suitable material may be used. In the case of both bottom end cap 18 and o-ring 20, the materials used in the construction of these components may vary depending on the chemicals likely to contact these components during a particular use of centrifuge rotor 10.

Both top end cap 12 and bottom end cap 18 include openings for fluid flow either into or out of centrifuge rotor 10. Top end cap 12 includes fluid outlet 24, through which a sample fluid within centrifuge rotor 10 may exit centrifuge rotor 10. During use of centrifuge rotor 10 in a continuous fluid flow manner, a fluid sample exits centrifuge rotor 10 via fluid inlet 24.

Bottom end cap 18 includes fluid inlet 26 for fluid flow into centrifuge rotor 10. During use of centrifuge rotor 10 in a continuous fluid flow manner, sample fluid enters centrifuge rotor 10 via fluid inlet 26. After a sample has been separated and a gradient established within centrifuge rotor 10, however, the sample is also removed through fluid outlet 26. In some uses of centrifuge rotor 10, a solution used to establish a gradient within centrifuge rotor 10 may enter centrifuge rotor 10 through fluid outlet 24.

The internal diameters of both fluid inlet 24 and fluid outlet 26 may vary, with any suitable internal diameters being used in the construction of the inlet and outlet. Fluid inlet 24 and fluid outlet 26 may have the same internal diameters or may have internal diameters different from one another.

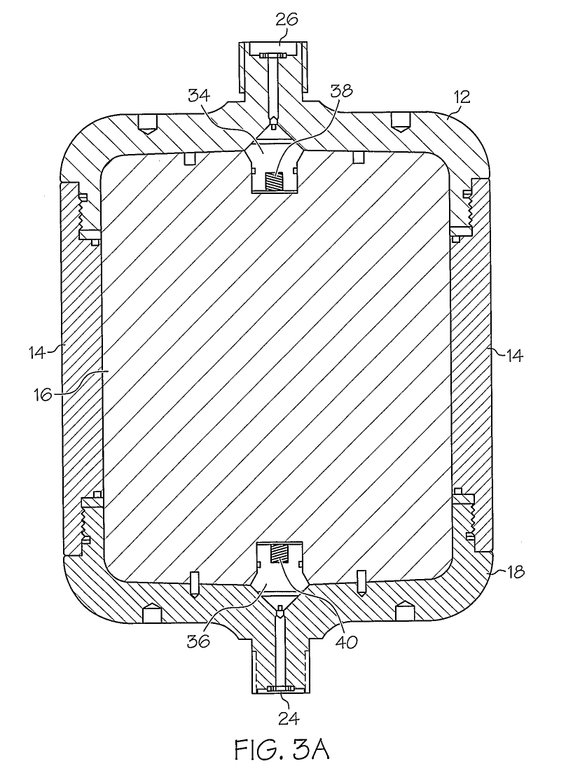

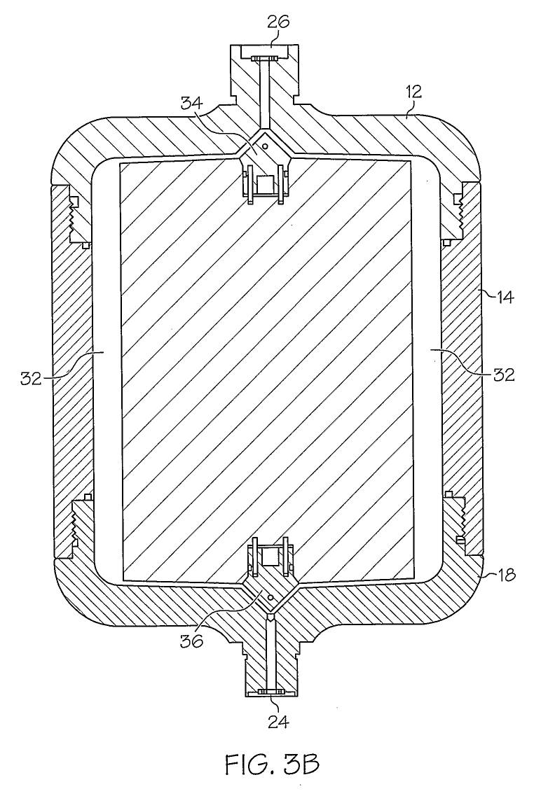

FIGS. 3A and 3B provide longitudinal cross-sectional views of a complete centrifuge rotor constructed in accordance with the teachings of the present invention. Top end cap 12 and bottom end cap 18 are securely fastened to rotor housing 14 (by being screwed thereon in the illustrated embodiment of the present invention). Rotor core 16 is contained therein. The position of distributors 34 and 36 are also shown. In FIG. 3A, springs 38 and 40 are shown as well. The cross-section of FIG. 3A does not include any of channels 30. The cross-section of FIG. 3B does bisect two of channels 30 and, thus, sample space 32 is shown positioned between rotor core 16 and rotor housing 14.

As has been noted above, it has been unexpectedly found that centrifuge rotors having L/D ratios approaching one are stable when constructed in accordance with the teachings of the present invention. This stability is due in part to the balancing effect of the size and orientation of channels 30 of centrifuge rotor 10. In the embodiment shown in the Figures, four channels 30 are used, each sized to hold about 25 ml of fluid in sample chambers 32 created between channel 30 and interior wall of rotor housing 14. Thus, the centrifuge rotor 10 as shown in the Figures has a total capacity of about 100 ml. In an alternative embodiment, six channels 30 may be used, creating six sample chambers 32, each holding about 16.7 ml of sample fluid. Various alternative configurations can be used, including as few as three channels, creating three sample chambers 32, each holding about 33.3 ml of sample fluid, or as many as thirty-six channels 30. In addition, various rotors can be constructed holding more or less than about 100 ml of sample fluid without departing from the spirit and scope of the present invention. Such rotors may hold as much as about 300 ml total sample fluid, or as little as about 25 ml total sample fluid. Rotors having capacities within the range of about 25 ml to about 300 ml are preferred, though the present invention is not limited to that range. More preferred are rotors having capacities within the range of about 33 ml to about 100 ml. Yet more preferred are rotors having capacities within the range of from about 25 ml to about 75 ml, and from about 25 ml to about 50 ml. Most preferred are rotors having a total capacity of about 25 ml, wherein four channels 30 are used, each forming a sample chamber having a capacity of about 6.25 ml.

Heretofore, the physical structure of centrifuge rotor 10 has been described. Now, the use of centrifuge rotor 10 in normal operation will be detailed. Centrifuge rotor 10 is adaptable for use in any of various commercially-available ultracentrifuges, said ultracentrifuges being well-known in the art.

Centrifuge rotor 10 is assembled with the various components thereof arranged as shown in FIG. 1. Once the rotor is assembled, a means of directing sample into centrifuge rotor 10 is affixed to fluid inlet 26. For this purpose, various types of tubing may be used, as well as various other methods of sample delivery known in the art. It is contemplated that any suitable means of sample delivery may be used. In addition, a means of allowing the fluid sample carrier to leave centrifuge rotor 10 (after directing sample thereto) is affixed to fluid outlet 24. For this purpose, various types of tubing may also be used, in addition to various other methods known in the art. It is again contemplated that any suitable means may be used.

A fluid sample may be fed into centrifuge rotor 10 using a fluid pump that is able to achieve a maximum flow rate equal to or exceeding the desired flow rate of fluid through centrifuge rotor 10. If the pump produces a flow rate in excess of that desired for fluid flow through centrifuge rotor 10, a sample discharge control valve may be used to control the precise rate of fluid flow through centrifuge rotor 10. As noted above, the pressure of sample fluid allowed by the fluid pump and controlled by a sample discharge control valve will vary depending on the ratio of length to diameter of sample chamber 32 and the desired fluid flow rate therethrough. A flow meter may also be provided in order to measure the rate of fluid flow through centrifuge rotor 10. Fluid pumps, sample discharge control valves, and flow meters are well-known in the art and any suitable devices may be used for these purposes.

Initially, the fluid being used to establish a gradient is allowed to flow into centrifuge rotor 10. Preferably, such a fluid may be a sucrose solution, though various other solutions such as cesium chloride, cesium sulfate, sodium bromide, cesium formate, and potassium bromide may also be used. Any suitable gradient-forming solution may be used so long as the chemicals used in establishing the gradient are compatible with the materials used in the construction of any given centrifuge rotor. Once the fluid being used to establish a gradient has filled sample chambers 32 of centrifuge rotor 10, centrifuge rotor 10 is spun at a relatively low rate of speed in order to allow the gradient to form. The rates of speed required for various gradient-establishing solutions are well-known in the art and for certain solutions a ramped rate of acceleration may be used to establish the gradient and minimize mixing of gradient-forming compounds. For example, a solution of 60% w/v sucrose and 0.05% EDTA, loaded in conjunction with a suitable buffer solution, can be utilized to establish a 0-60% gradient with ramped acceleration. In addition the above, the gradient-forming solution may be pumped into centrifuge rotor 10 via fluid outlet 26 rather than fluid inlet 24. Once the gradient is established, centrifuge rotor 10 is brought up to operational speed and the fluid sample is introduced into the rotor.

Operational speed for centrifuge rotor 10 will vary depending upon the particular application for which centrifuge rotor 10 is being used. Ultracentrifuge rotor speeds may reach 40,500 rpm or more. A fluid sample is introduced into centrifuge rotor 10, having a gradient established therein, at a speed appropriate to the application at hand. Further, the fluid sample may be loaded at a speed lower than that at which centrifuge rotor 10 will be run for purposes of sample separation. For example, during isolation of various lipoproteins, the sample may be loaded at 30,000 rpm, while centrifuge rotor 10 is run at 40,000 rpm for a predetermined time period in order to achieve separation. Alternatively, in order to separate organelles, for example, a sample may be loaded at 20,000 rpm and centrifuge rotor 10 run at 35,000 rpm for a predetermined time period.

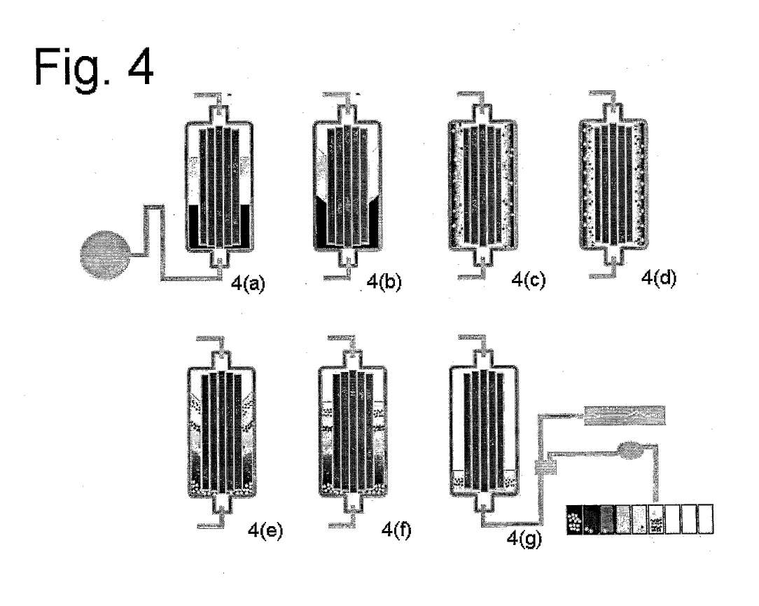

The establishment of a gradient and separation of sample in a centrifuge rotor constructed in accordance with the teachings of the present invention is presented in FIG. 4. FIG. 4(a) illustrates the loading of a step gradient at rest, with the gradient being loaded via fluid inlet 26 in bottom end cap 18 of centrifuge rotor 10. The various bands of density established in the gradient are illustrated by the white, grey, and black bands within centrifuge rotor 10. FIG. 4(b) shows the reorientation of the established gradient during acceleration. The gradient begins to reform from a horizontal gradient to a vertical gradient. In other words, the gradient shifts from one established along a cross-sectional diameter of centrifuge rotor 10 to one established along a vertical length of centrifuge rotor 10. This shifting of the gradient is due to centrifugal forces within centrifuge rotor 10. FIG. 4(c) illustrates the introduction of a fluid sample (represented by black, white, and grey dots within centrifuge rotor 10) into centrifuge rotor 10. The fluid is preferably introduced via fluid inlet 26. The continuous fluid sample flow indicated in FIG. 4(c) is allowed to continue until the entire sample from which components are to be extracted has passed through centrifuge rotor 10 and has spent sufficient time within centrifuge rotor 10 to be separated along the gradient established therein. Alternatively, in uses of centrifuge rotor 10 wherein trace components in a large sample are to be concentrated, the continuous flow of fluid sample into centrifuge rotor 10 is allowed to continue until it is determined that a desired level of concentration has been reached.

FIG. 4(d) illustrates the condition of the sample and the established gradient once fluid sample flow into centrifuge rotor 10 has ended. As shown in the Figure, isopycnic banding of the separated sample is achieved. FIG. 4(e) illustrates another shifting of the density gradient during deceleration of centrifuge rotor 10. As the density gradient shifts, the components of the separated sample remain in the density bands into which they were separated during operation of centrifuge 10. In FIG. 4(f) centrifuge rotor 10 is at rest and the shifting of the density gradient is complete. The density gradient has shifted from a vertical gradient back to a horizontal gradient, with each of the components of the sample remaining in the density band into which it was separated during operation of centrifuge rotor 10. As shown in FIG. 4(g), removal of the sample is simple once centrifuge rotor 10 is at rest. The sample is removed through fluid outlet 26 and, because of the density gradient established within centrifuge rotor 10, the sample is removed in discrete bands containing certain fractions or components of the sample and can therefore be separated into receptacles based on fractions containing the desired separated components. Thus, components of the sample have been effectively separated for analysis. In other uses of centrifuge rotor 10, a trace component of a sample is concentrated in a particular band in the density gradient and is eluted in the same manner as that shown in FIG. 4.

### EXAMPLE 1

Now provided is an example detailing the use of a rotor constructed in accordance with the present invention.

Rat livers were obtained from Zivic Laboratories, Inc. Livers were collected from 8-10 week old male Sprague-Dawley rats and snap frozen in liquid nitrogen. 12 g liver was thawed in 1×PBS at room temperature. Tissues were then homogenized for 10 seconds on the low setting, 10 seconds on the high setting and 10 seconds on the low setting using a Waring 200 mL blender in homogenization buffer (20 mM HEPES/5 mM MgCl₂/500 mM sucrose, pH 7.2). Nuclei were pelleted at 1,076×g for 10 minutes and the pellets were resuspended in 24 mL homogenization buffer by swirling/shaking, blended using the same settings and centrifuged a second time at 1,076×g for 10 minutes for maximal recovery of organelles. Supernatants were combined and diluted 1:1 with 20 mM HEPES/5 mM MgCl₂, pH 7.2, for pCFU.

An Alfa Wassermann Focus pCFU with a 114 mL rotor core was used for pCFU. The rotor was initially filled with 114 mL 20 mM HEPES/5 mM MgCl₂/250 mM sucrose, pH 7.2 (flow buffer). After clearing air from all channels by accelerating first to 5K rpm and then to 20K rpm, the rotor was brought to rest and 57 mL of 60% w/v sucrose/20 mM HEPES/5 mM MgCl₂, pH 7.2 was pumped into the bottom of the rotor using a syringe pump at 10 mL/minute. Ramped acceleration to 3.5K rpm established a linear 14-49% sucrose gradient. About 160 mL homogenized tissue sample was loaded at 10 mL/minute using a peristaltic pump with the rotor spinning at 20K rpm. Sample was chased into the rotor with about 60 mL of flow buffer. The flow-through was collected and reloaded at 10 mL/minute using a peristaltic pump with the rotor running at 35K rpm to maximize the entry of sample components into the gradient. The reloaded flow-through was chased into the rotor with about 30 mL of flow buffer. The final flow-through was collected. The sample was banded at 35K rpm for 2 hrs. Following controlled deceleration to minimize mixing, 2 mL fractions were collected with the rotor at rest. All fractions were split into two 1 mL aliquots. One set of fractions was stored at −80° C. and the other was stored at 4° C. overnight for analysis.

It will be obvious to those of skill in the art upon reading this disclosure that many variations of the present invention are possible without departing from the spirit or scope of the invention described herein. The number and kind of modifications that may be made to the present device are varied and large, and it is contemplated that such modifications are within the scope of the present invention. The specific embodiments described herein are given by way of example only, and the present invention is limited only by the appended claims.

What is claimed is:

1. A centrifuge rotor comprising:
a rotor housing substantially cylindrical in shape having an interior wall and further having a substantially uniform opening extending through a center and along a length thereof; and
a rotor core having a substantially cylindrical shape and adapted to be received within said substantially uniform opening of said rotor housing, said rotor core further comprising at least two channels in an outer surface thereof,
wherein said channels and said interior wall of said rotor housing define at least two sample spaces within said rotor, and further wherein said centrifuge rotor has an L/D ratio in a range of from about 0.9 to about 1.3.

2. A centrifuge rotor according to claim 1 further comprising a first end cap removably attached to a first end of said rotor housing and a second end cap removably attached to a second end of said rotor housing.

3. A centrifuge rotor according to claim 2 wherein said first end cap comprising a fluid inlet and said second end cap comprises a fluid outlet.

4. A centrifuge rotor according to claim 2 further comprising a first seal ring for creating a seal between said first end cap and said rotor housing and a second seal ring for creating a seal between said second end cap and said rotor housing.

5. A centrifuge rotor according to claim 1 wherein said rotor core comprises a central bore extending along a length thereof.

6. A centrifuge rotor according to claim 1 wherein said sample spaces are adapted to receive a volume in the range of from about 6.25 ml to about 100 ml.

7. A centrifuge rotor according to claim 1 wherein said sample spaces are adapted to receive a volume selected from the group consisting of 100 ml, 75 ml, 25 ml, 15 ml, 10 ml, and 6.25 ml.

8. A centrifuge rotor according to claim 1 wherein said centrifuge rotor has an L/D ratio in a range of from about 1.03 to about 1.30.

9. A centrifuge rotor according to claim 1 wherein said centrifuge rotor has an L/D ratio in a range of from about 1.03 to about 1.25.

10. A centrifuge rotor according to claim 1 wherein said centrifuge rotor has an L/D ratio in a range of from about 1.03 to about 1.20.

11. A centrifuge rotor according to claim 1 wherein said centrifuge rotor has an L/D ratio in a range of from about 1.03 to about 1.15.

12. A centrifuge rotor according to claim 1 wherein said centrifuge rotor has an L/D ratio in a range of from about 1.03 to about 1.10.

13. A centrifuge rotor according to claim 1 wherein said centrifuge rotor has an L/D ratio in a range of from about 1.03 to about 1.05.

14. A centrifuge rotor according to claim 1 wherein said centrifuge rotor has an L/D ratio of about 1.03.

15. A centrifuge rotor comprising:
a rotor housing substantially cylindrical in shape having an interior wall and further having a substantially uniform opening extending through a center and along a length thereof;
a rotor core having a substantially cylindrical shape and adapted to be received within said substantially uniform opening of said rotor housing, said rotor core further comprising at least two channels in an outer surface thereof;
a first end cap removably attached to a first end of said rotor housing, said first end cap comprising a fluid inlet;
a second end cap removably attached to a second end of said rotor housing, said second end cap comprising a fluid outlet;
a first seal ring positioned between said first end cap and a first end of said rotor housing for creating a seal between said first end cap and said rotor housing; and
a second seal ring positioned between said second end cap and a second end of said rotor housing for creating a seal between said second end cap and said rotor housing,
wherein said channels and said interior wall of said rotor housing define at least two sample spaces within said rotor, and further wherein said centrifuge rotor has an L/D ratio in a range of from about 0.9 to about 1.3.

16. A centrifuge rotor according to claim 15 wherein said sample spaces are adapted to receive a volume in the range of from about 6.25 ml to about 100 ml.

17. A centrifuge rotor according to claim 15 wherein said sample spaces are adapted to receive a volume selected from the group consisting of 100 ml, 75 ml, 25 ml, 15 ml, 10 ml, and 6.25 ml.

18. A centrifuge rotor according to claim 15 wherein said centrifuge rotor has an L/D ratio in a range of from about 1.03 to about 1.30.

19. A centrifuge rotor according to claim 15 wherein said centrifuge rotor has an L/D ratio in a range of from about 1.03 to about 1.25.

20. A centrifuge rotor according to claim 15 wherein said centrifuge rotor has an L/D ratio in a range of from about 1.03 to about 1.20.

21. A centrifuge rotor according to claim 15 wherein said centrifuge rotor has an L/D ratio in a range of from about 1.03 to about 1.15.

22. A centrifuge rotor according to claim 15 wherein said centrifuge rotor has an L/D ratio in a range of from about 1.03 to about 1.10.

23. A centrifuge rotor according to claim 15 wherein said centrifuge rotor has an L/D ratio in a range of from about 1.03 to about 1.05.

24. A centrifuge rotor according to claim 15 wherein said centrifuge rotor has an L/D ratio of about 1.03.

25. A method of separating components of a fluid sample comprising:
a) introducing a gradient-forming solution into a centrifuge rotor, said centrifuge rotor comprising:
a rotor housing substantially cylindrical in shape having an interior wall and further having a substantially uniform opening extending through a center and along a length thereof;
a rotor core having a substantially cylindrical shape and adapted to be received within said substantially uniform opening of said rotor housing, said rotor core further comprising at least two channels in an outer surface thereof;
a first end cap removably attached to a first end of said rotor housing, said first end cap comprising a fluid inlet;
a second end cap removably attached to a second end of said rotor housing, said second end cap comprising a fluid outlet;
a first seal ring positioned between said first end cap and a first end of said rotor housing for creating a seal between said first end cap and said rotor housing; and
a second seal ring positioned between said second end cap and a second end of said rotor housing for creating a seal between said second end cap and said rotor housing,
wherein said channels and said interior wall of said rotor housing define at least two sample spaces within said rotor, and further wherein said centrifuge rotor has an L/D ratio in a range of from about 0.9 to about 1.3,
b) running said centrifuge rotor at a velocity sufficient for said gradient-forming solution to form a vertical gradient therein;
c) introducing a continuous-flow fluid sample into said centrifuge rotor through the fluid inlet of said first end cap;
d) continuing to introduce said continuous-flow fluid sample into said centrifuge rotor for a predetermined length of time, allowing at least some of the individual components of said continuous-flow fluid sample to be separated by the gradient formed in said centrifuge rotor by said gradient-forming solution;
e) stopping the flow of said continuous-flow fluid sample into said centrifuge rotor;
f) stopping said centrifuge rotor such that the gradient formed therein shifts to become a horizontal gradient, said gradient still containing said separated components therein; and
g) removing said gradient-forming solution containing said separated components from said centrifuge rotor through said fluid outlet, thereby retrieving said separated components from said centrifuge rotor.

26. A centrifuge rotor comprising:
a rotor housing substantially cylindrical in shape having an interior wall and further having a substantially uniform opening extending through a center and along a length thereof;
a rotor core having a substantially cylindrical shape and adapted to be received within said substantially uniform opening of said rotor housing, said rotor core further comprising at least two channels in an outer surface thereof;
a first end cap removably attached to a first end of said rotor housing, said first end cap comprising a fluid inlet;
a second end cap removably attached to a second end of said rotor housing, said second end cap comprising a fluid outlet;
a first seal ring positioned between said first end cap and a first end of said rotor housing for creating a seal between said first end cap and said rotor housing; and
a second seal ring positioned between said second end cap and a second end of said rotor housing for creating a seal between said second end cap and said rotor housing,
wherein said channels and said interior wall of said rotor housing define at least two sample spaces within said rotor, and further wherein said rotor core has an L/D ratio in a range of from about 0.9 to about 1.3.

27. A centrifuge rotor according to claim 26 wherein said sample spaces are adapted to receive a volume in the range of from about 6.25 ml to about 100 ml.

28. A centrifuge rotor according to claim 26 wherein said sample spaces are adapted to receive a volume selected from the group consisting of 100 ml, 75 ml, 25 ml, 15 ml, 10 ml, and 6.25 ml.

29. A centrifuge rotor according to claim 26 wherein said rotor core has an L/D ratio in a range of from about 1.03 to about 1.30.

30. A centrifuge rotor according to claim 26 wherein said rotor core has an L/D ratio in a range of from about 1.03 to about 1.25.

31. A centrifuge rotor according to claim 26 wherein said rotor core has an L/D ratio in a range of from about 1.03 to about 1.20.

32. A centrifuge rotor according to claim 26 wherein said rotor core has an L/D ratio in a range of from about 1.03 to about 1.15.

33. A centrifuge rotor according to claim 26 wherein said rotor core has an L/D ratio in a range of from about 1.03 to about 1.10.

34. A centrifuge rotor according to claim 26 wherein said rotor core has an L/D ratio in a range of from about 1.03 to about 1.05.

35. A centrifuge rotor according to claim 26 wherein said rotor core has an L/D ratio of about 1.03.

36. A centrifuge rotor comprising:
a rotor housing substantially cylindrical in shape having an interior wall and further having a substantially uniform opening extending through a center and along a length thereof; and
a rotor core having a substantially cylindrical shape and adapted to be received within said substantially uniform opening of said rotor housing, said rotor core further comprising at least two channels in an outer surface thereof,
wherein said channels and said interior wall of said rotor housing define at least two sample spaces within said rotor, and further wherein said rotor core has an L/D ratio in a range of from about 0.9 to about 1.3.

37. A centrifuge rotor according to claim 36 further comprising a first end cap removably attached to a first end of said rotor housing and a second end cap removably attached to a second end of said rotor housing.

38. A centrifuge rotor according to claim 37 wherein said first end cap comprising a fluid inlet and said second end cap comprises a fluid outlet.

39. A centrifuge rotor according to claim 37 further comprising a first seal ring for creating a seal between said first end cap and said rotor housing and a second seal ring for creating a seal between said second end cap and said rotor housing.

40. A centrifuge rotor according to claim 36 wherein said rotor core comprises a central bore extending along a length thereof.

41. A centrifuge rotor according to claim 36 wherein said sample spaces are adapted to receive a volume in the range of from about 6.25 ml to about 100 ml.

42. A centrifuge rotor according to claim 36 wherein said sample spaces are adapted to receive a volume selected from the group consisting of 100 ml, 75 ml, 25 ml, 15 ml, 10 ml, and 6.25 ml.

43. A centrifuge rotor according to claim 36 wherein said rotor core has an L/D ratio in a range of from about 1.03 to about 1.30.

44. A centrifuge rotor according to claim 36 wherein said rotor core has an L/D ratio in a range of from about 1.03 to about 1.25.

45. A centrifuge rotor according to claim 36 wherein said rotor core has an L/D ratio in a range of from about 1.03 to about 1.20.

46. A centrifuge rotor according to claim 36 wherein said rotor core has an L/D ratio in a range of from about 1.03 to about 1.15.

47. A centrifuge rotor according to claim 36 wherein said rotor core has an L/D ratio in a range of from about 1.03 to about 1.10.

48. A centrifuge rotor according to claim 36 wherein said rotor core has an L/D ratio in a range of from about 1.03 to about 1.05.

49. A centrifuge rotor according to claim 36 wherein said rotor core has an L/D ratio of about 1.03.
